(19) United States
(12) Patent Application Publication
(10) Pub. No.: US 2025/0263143 A1
(43) Pub. Date: Aug. 21, 2025

(54) VARIABLE SUPPORT TRAINING WHEEL

(71) Applicant: Robert Edward Kirkpatrick, Topsfield, MA (US)

(72) Inventor: Robert Edward Kirkpatrick, Topsfield, MA (US)

(21) Appl. No.: 18/937,108

(22) Filed: Nov. 5, 2024

Related U.S. Application Data
(60) Provisional application No. 63/556,365, filed on Feb. 21, 2024.

(51) Int. Cl. B62H 1/12; B62H 7/00

(52) U.S. Cl. CPC B62H 1/12; B62H 7/00

(57) ABSTRACT

The present invention relates to a training wheel assembly for bicycles that enables riders to develop balance while improving performance. This assembly features an adjustable tension system with discrete settings to gradually reduce support as the rider's skills improve, ensuring balanced forces on both sides for stability. A rotational stop feature prevents excessive tilting, while simplified components such as a top bracket, bottom bracket, pivot pin, and tensioning element streamline construction. The tension mechanism utilizes elastic materials and discrete adjustment points, offering a controlled, customizable riding experience for beginners.

### TECHNICAL FIELD

Embodiments disclosed herein relate generally to training wheels for bicycles and more specifically to training wheels for two wheeled bicycles.

### BACKGROUND ART

Training wheels, as they are currently designed, enable riders to learn pedaling but often hinder their ability to develop balancing skills. Prior designs reveal a significant limitation: the rigid structure of traditional training wheels prevents riders from learning balance while using them.

Balancing on a bicycle involves three primary elements: (1) the tilt of the bicycle relative to gravity, (2) the bicycle's speed, and (3) the angle between the front and rear wheels (or degree of turning). For experienced riders, the coordination of these elements becomes intuitive. To maintain balance while turning, riders lean into the turn proportionally to the degree of the turn and inversely proportional to their speed. Conversely, to regain balance, riders turn at an angle that correlates with how off-balance they are, again inversely proportional to their speed.

Rigid training wheels restrict the essential leaning motion needed for balance. This invention addresses that limitation, offering improvements over prior designs in both performance and manufacturability.

Previous designs suggested adding elasticity or spring loading to allow for necessary tilting. However, these systems often fall short. A key issue with earlier designs is that the spring constant is typically fixed, making it difficult to gradually reduce the rider's reliance on the support. Adjusting tension or compression settings in these designs is also challenging, often leading to imbalances between the left and right training wheels.

Another drawback is the significant spring force needed to support a beginner rider. This force is either so high that it compresses the spring in a neutral (upright) state—potentially lifting the rear wheel and halting the bike's movement—or the spring is left too stiff, restricting the rider's ability to experience meaningful tilt.

In terms of manufacturability, most previous systems use a compression spring, which requires a support rod. This rod, an additional component, necessitates an extra hinge, adding to the complexity and cost of production.

The present invention offers a solution that overcomes the limitations of prior art by introducing a training wheel assembly that incorporates a variable, adjustable tensioning system. This system allows the rider to experience a controlled degree of tilt, essential for learning balance while gradually reducing dependency on the training wheels. Unlike rigid designs, this assembly enables the training wheels to respond dynamically to the rider's weight and movement, providing a balanced spring force that avoids excessive compression or stiffness. The design is also simplified, reducing the need for additional components like support rods or extra hinges, enhancing both manufacturability and ease of use. As a result, this invention delivers an improved learning experience and supports a smoother transition from assisted riding to independent balance.

### SUMMARY OF THE EMBODIMENTS

In various aspects, a training wheel assembly is provided.

This invention introduces several performance improvements, including an adjustable tension setting that enables gradual reduction of support as the rider's balance improves. In different embodiments, the trainer can set the tension to specific locations, making adjustments straightforward. Adjusting the tension is done by pulling the tensioning component over, through, or around certain features on the assembly, securing it at the chosen position. This system allows for easy adjustments, ensuring balanced forces on both training wheels so the rider experiences consistent stability when leaning to either side, facilitating the learning process.

In traditional designs, a spring force is typically applied to push the training wheels downward, keeping the bicycle upright. This invention, however, integrates a rotational stop feature within the training wheel hinge, which prevents the bicycle from tilting past its normal upright position. This feature allows for a significant tension force to aid beginner riders while also stopping the training wheels from rotating too far outward, ensuring stability even if the rider leans excessively.

To enhance manufacturability, one embodiment of this invention includes only a top bracket, bottom bracket, pivot pin, tensioning component, and a small wheel with a nut and bolt for mounting.

The training wheel assembly may include two or more brackets. One bracket, referred to as the “top bracket,” may be connected directly to the main wheel, while another bracket, the “bottom bracket,” may connect to the training wheel. These brackets are joined by a pin that allows them to pivot relative to each other, with an optional secondary pin to lock their positions.

Tension between the brackets may be generated by an elastic or spring element. The elastic may have a braided outer layer that limits stretch, similar to a “bungee cord.” Tension can be achieved with a single elastic, multiple elastics, or an elastic loop or band. The material may be a spring, elastomer, or another elastic material.

Tension may pull the training wheel toward the main back wheel, promoting an upright position relative to the ground. Tension points may be located directly on the brackets. On the bottom bracket, these points could be positioned on either side of the pivot created by the primary pin. The bracket may include a feature for adjusting the length and positioning of the tension component by wrapping it around certain points.

The tension is adjustable to suit the rider's experience level, with higher tension suited for beginners. Tension settings may be discrete or continuous. Discrete adjustments are made by looping the tension component around specific knobs or grooves on the brackets. These knobs may include a central groove for tool access, allowing easy adjustments. A hook-shaped tool may be used to capture and adjust the tension component. In another design, the tension is adjusted by pulling an elastic with a variable diameter through slots of different sizes, locking it into place as needed.

The brackets are restricted from pivoting beyond a specified range, allowing for pre-tensioning when the training wheel is upright. This limit prevents the training wheel from extending past a point where the rider might lose balance.

The bracket attached to the main wheel includes a feature that limits rotation of the training wheel assembly in relation to the direction of the back wheel, using the slot that houses the back wheel as a guide.

Other aspects, embodiments and features of the device and method will become apparent from the following detailed description when considered in conjunction with the accompanying figures. The accompanying figures are for schematic purposes and are not intended to be drawn to scale. In the figures, each identical or substantially similar component that is illustrated in various figures is represented by a single numeral or notation. For purposes of clarity, not every component is labeled in every figure. Nor is every component of each embodiment of the device and method shown where illustration is not necessary to allow those of ordinary skill in the art to understand the device and method.

### BRIEF DESCRIPTION OF THE DRAWINGS

The preceding summary, as well as the following detailed description of the disclosed device and method, will be better understood when read in conjunction with the attached drawings. It should be understood, however, that neither the device nor the method is limited to the precise arrangements and instrumentalities shown.

FIG. 1 is a side view of the training wheel assembly, demonstrating one embodiment of the present invention.

FIG. 2A illustrates one embodiment of the present invention for the bottom bracket with the training wheel attached.

FIG. 2B shows one embodiment of the present invention for the bottom bracket without the training wheel attached, highlighting features otherwise obscured by the wheel.

FIG. 3A provides a top-down perspective view of the top bracket, showcasing one embodiment of the present invention for the tensioning component.

FIG. 3B depicts a bottom-up perspective view of the top bracket as one embodiment of the present invention.

FIG. 4 shows a perspective view illustrating the interaction between the top bracket and the bicycle's bracketing system, wherein the top bracket's structure is configured to align and secure its rotational orientation relative to the bicycle frame, enabling stable attachment and supporting the training wheel assembly.

FIG. 5A displays a bottom-up perspective of the training wheel assembly with the tensioning system clamped (tensioning component not shown) in one embodiment of the present invention.

FIG. 5B presents a bottom-up perspective of the training wheel assembly with the tensioning system in the open position (tensioning component not shown) in one embodiment of the present invention.

FIG. 6 illustrates a side view of the training wheel assembly installed on a bicycle leaning to the right, representing one embodiment of the present invention.

### DETAILED DESCRIPTION OF SPECIFIC EMBODIMENTS

The following discussion and illustrations demonstrate the principles of the invention. It is understood that skilled practitioners can devise alternative configurations that, while not explicitly detailed or depicted here, embody the invention's principles and fall within its scope. The examples provided primarily serve to aid in understanding the invention's principles and the inventor's contributions to the field. These examples are illustrative and not limited to the specific scenarios or conditions described.

The term “or” denotes a non-exclusive alternative unless specified otherwise (e.g., “or else” or “or in the alternative”). Additionally, the various embodiments outlined here are not necessarily mutually exclusive; certain embodiments can combine with others to form new configurations.

The innovative teachings of this application are illustrated with specific reference to preferred embodiments. However, it is crucial to understand that these embodiments represent just a few of the advantageous applications of the disclosed concepts. Statements in the application generally do not limit the claimed inventions, as some may be relevant to certain features but not others. Those skilled in the field, guided by the teachings here, will recognize the invention's broader applicability across various technical areas or embodiments.

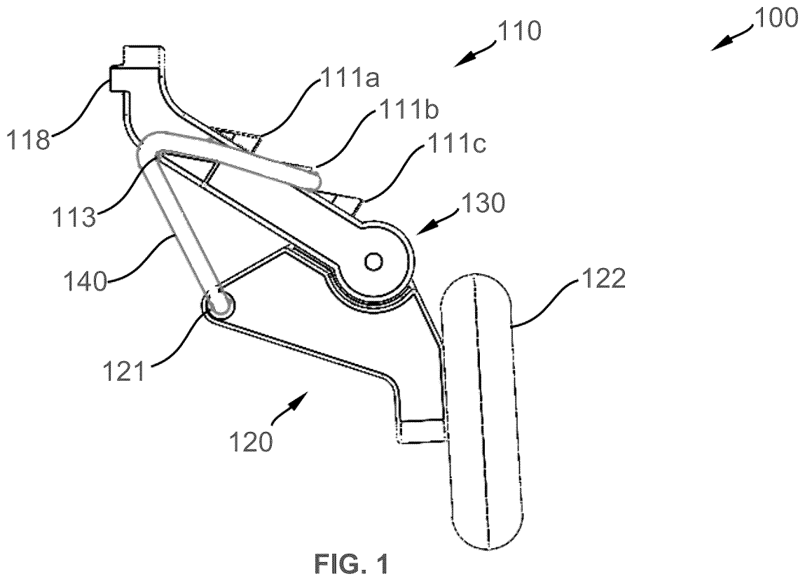

As shown in FIG. 1, a training wheel assembly (100) is provided in one embodiment. This assembly includes a top bracket (110) with a frame mounting feature (118) designed to attach securely to the bicycle frame, preventing rotation about the wheel's axis. The assembly also includes a bottom bracket (120), which connects to the training wheel (122). The hinge system (130) allows the brackets to rotate freely relative to each other around a pivot pin (133). A tensioning component (140) applies force between a fixed termination point (121) on one bracket and variable termination points (111a, 111b, or 111c) on the other, creating the necessary balance forces. The top and bottom brackets may both include fixed or variable termination points, allowing flexible tensioning configurations. The tensioning component may also pivot or redirect around a routing feature (113), guiding force to draw the training wheel towards the top bracket mount.

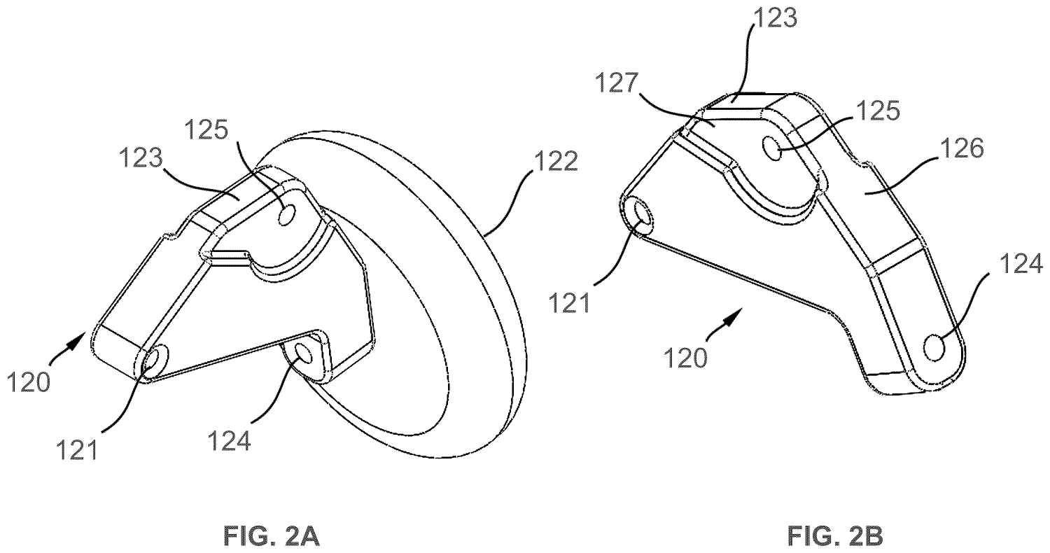

As illustrated in FIG. 2A, the bottom bracket (120) includes a fixed termination point (121) where the tensioning component (from FIG. 1) is secured. The training wheel (122) attaches to the bottom bracket with a bolt (124). A rotational stop feature (123) prevents the bottom bracket from over-rotating inward, and a pivot pin mounting feature (131) allows it to rotate within the assembly.

As shown in FIG. 2B, the bottom bracket (120) includes an emergency rotational stop feature (126) to prevent it from over-rotating, which could otherwise cause the rider to lose balance. The hinge knuckle (134) is also part of the hinge, facilitating controlled rotation.

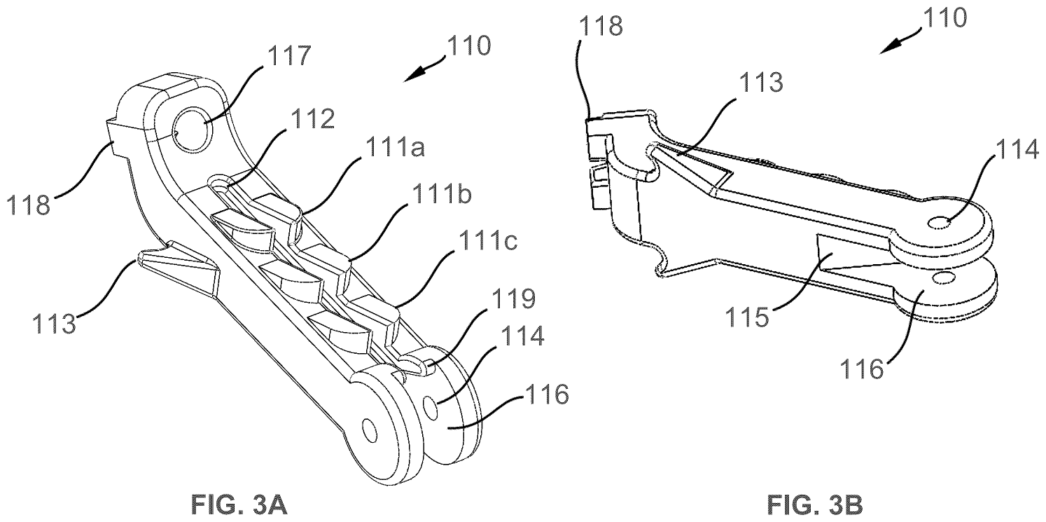

As illustrated in FIG. 3A, the top bracket (110) includes a mounting hole (117) for positioning the training wheel assembly over the bicycle wheel's axis, along with a frame mounting feature (118) to prevent rotation relative to the frame. This mounting feature may be an integral part of the top bracket or a separate component. The top bracket includes variable termination points (111a, 111b, and 111c) for securing the tensioning component (140). A slot (112) running through these termination points allows the tensioning component to be easily adjusted with a tool. A routing feature (113) on the top bracket directs the tensioning component to maximize torque. The top bracket also has a hinge knuckle (132) with a pivot pin mounting feature (135) for joining it to the bottom bracket. Emergency rotational stop (119) and tensioning rotational stop (115) features ensure the bracket does not rotate beyond a stable point.

As shown in FIG. 3B, a bottom-up perspective of the top bracket is provided, further demonstrating one embodiment of the present invention.

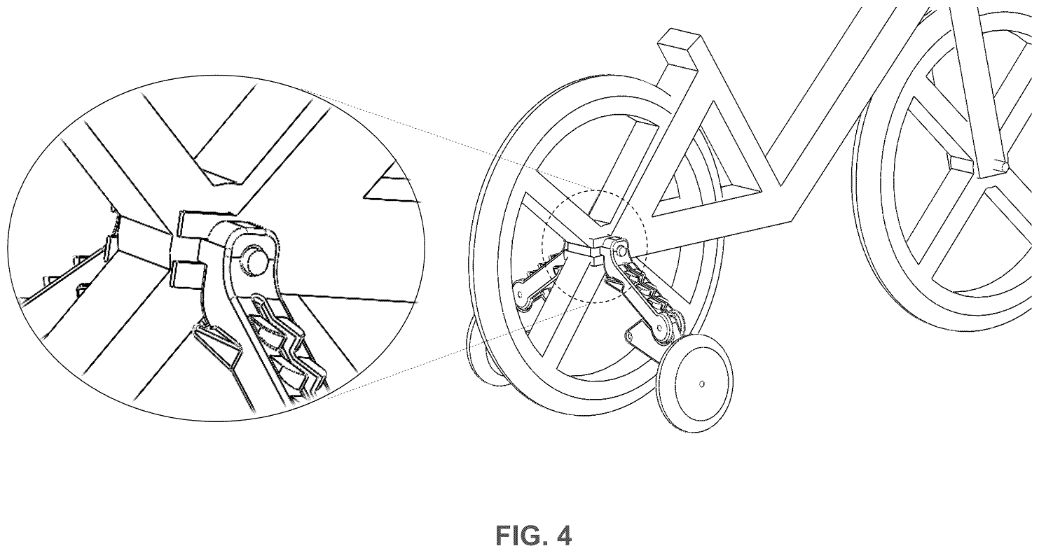

FIG. 4 offers, as illustrated, a perspective view showing how the top bracket interfaces with the bicycle's bracketing system, ensuring proper rotational orientation.

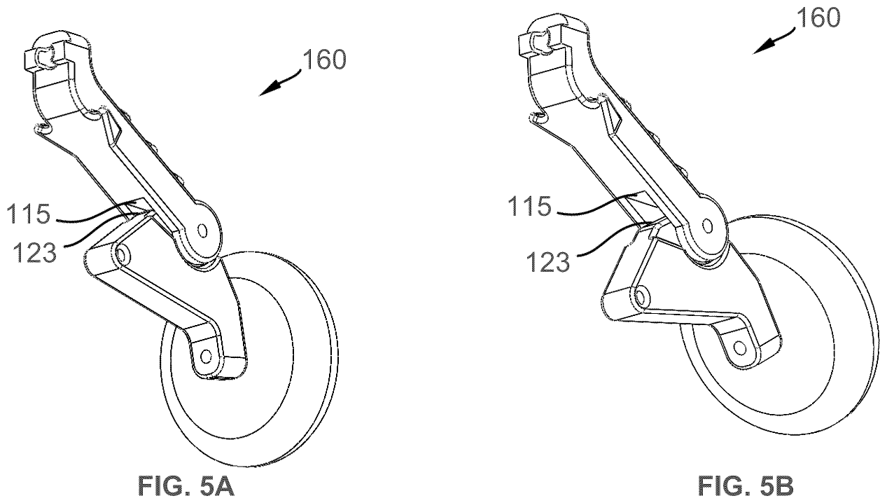

FIG. 5A displays a bottom-up perspective of the training wheel assembly with the tensioning system clamped (tensioning component not shown), as illustrated in one embodiment of the present invention.

As shown in FIG. 5B, a bottom-up perspective of the training wheel assembly is presented with the tensioning system open (tensioning component not shown), illustrating how the assembly functions under different tension states.

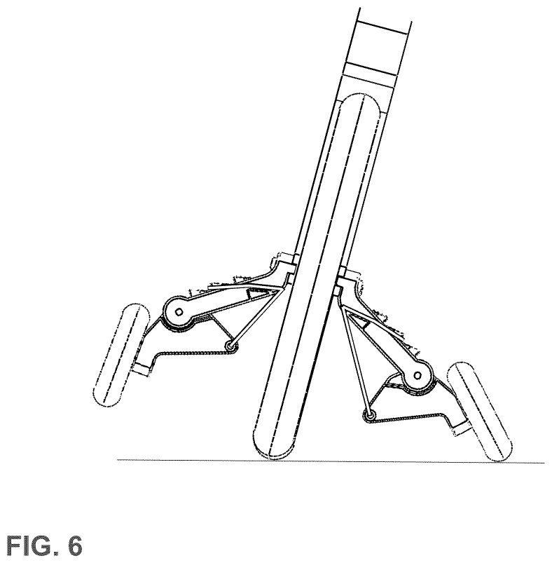

FIG. 6, as illustrated, provides a side view of the training wheel assembly mounted on a bicycle (400) leaning to the right, representing one embodiment of the present invention. This view demonstrates how the system supports the rider, with the tension component (140) pulling the bottom bracket upward and the training wheel (122) rotating outward to counteract gravity, providing increased support as the tensioning component lengthens in accordance with Hooke's Law. Adjusting the tension termination further down the top bracket at variable termination point 111c increases tension to support the rider further.

The training wheel assembly operates by dynamically adjusting the support provided to the rider, which is achieved through the adjustable tensioning component 140 (as shown in FIG. 1). This component includes multiple termination points on the top bracket 110 and bottom bracket 120, allowing for fine-tuned tension adjustments based on the rider's skill level. Initially, the tensioning component 140 can be set at a closer termination point, such as 111a, for beginners, providing stronger support that helps keep the bicycle upright. As the rider progresses, the component can be moved to a further termination point, like 111c, allowing for more tilt and promoting balance training (FIG. 3A).

In use, the tensioning component 140 exerts an inward force on the training wheels 122 (FIG. 2A), drawing them toward the main back wheel 300, and promoting an upright orientation for the bicycle. This inward pull is modulated by the elasticity of the tensioning component, allowing for slight tilts of the bicycle in response to the rider's movements. As the bicycle tilts, the training wheel on the side of the tilt rotates outward, extending the tensioning component 140. This extension increases resistance proportionally to the tilt, creating a self-regulating counterforce that aids the rider in regaining balance while leaning. The adjustability of the tension ensures that the support force applied by the training wheels can be tailored to the rider's experience, encouraging a gradual transition toward independent balance.

Several stop features integrated into the assembly help ensure safe operation by controlling the rotation of the top and bottom brackets. The tensioning rotational stop 115 on the top bracket (FIG. 3A) limits the inward rotation of the bottom bracket 120, ensuring the training wheels do not collapse inward, which could destabilize the bicycle. Additionally, the emergency rotational stop 126 on the bottom bracket (FIG. 2B) restricts maximum outward rotation, preventing the training wheel from rotating too far away from the bicycle, which could result in loss of balance. Together, these rotational stops help maintain the training wheels within a controlled range of motion, allowing stability without restricting the flexibility needed for effective balance training.

To install the training wheel assembly, the top bracket 110 is mounted over the rear axle 301 of the bicycle's back wheel, as illustrated in FIG. 6. The mounting hole 117 on the top bracket aligns with the bicycle's wheel axis, and the frame mounting feature 118 prevents rotation around the wheel axis once installed. The bottom bracket 120, which attaches to the training wheel 122, is connected to the top bracket via the pivot pin 133 (FIG. 1), allowing both brackets to rotate relative to each other. Once the assembly is in place, the tensioning component 140 is secured between fixed termination point 121 on the bottom bracket and a variable termination point (e.g., 111a, 111b, or 111c) on the top bracket, as shown in FIG. 3A. Adjusting the tension to suit the rider's skill level is straightforward, with higher tension settings offering more stability for beginners and lower tension settings providing less support for advanced riders.

As the rider's skills improve, the tension setting can be adjusted by moving the tensioning component 140 to a further termination point along the top bracket, like 111c, to reduce support. This incremental adjustment gradually decreases dependency on the training wheels, allowing the rider to rely more on their balance, ultimately facilitating a smooth transition to independent riding. By providing a customizable level of support, the assembly serves as a progressive training tool that adapts to the rider's evolving abilities.

The tensioning component 140, which may include a braided or reinforced outer layer, acts as a dynamic support mechanism. When the bicycle tilts to one side, as shown in FIG. 6, the tensioning component stretches, creating a counteracting force that stabilizes the rider. As the bicycle returns upright, the tension decreases, drawing the training wheels back toward the main wheel. This elastic response allows natural weight shifts and balance adjustments, essential for effective learning.

The frame mounting feature 118 and hinge system 130 ensure that the training wheel assembly remains securely attached to the bicycle, even as the brackets pivot and the tensioning component flexes. The hinge knuckles 132 and 134 on the top and bottom brackets, respectively (FIG. 3A and FIG. 2B), facilitate this independent pivoting action, allowing the training wheels on each side to adjust to the rider's shifts in balance. This design not only supports the rider but also enables the essential leaning and tilting movements fundamental to learning balance, bridging the gap between assisted and independent riding.

In accordance with some embodiments of the present invention, the method includes mounting the first bracket of the training wheel assembly to the rear axle of the bicycle frame to prevent rotation of the assembly relative to the frame, securing the training wheel to the second bracket to allow the second bracket to pivot relative to the first bracket about a pivot axis, and adjusting the tensioning component by selecting a termination point on at least one of the brackets to set an initial level of inward force that causes the training wheel to move toward the rear wheel of the bicycle, providing stability for the rider. The tensioning component is set to apply an adjustable inward force that supports the rider as the bicycle tilts, allowing the training wheel to extend outward when the bicycle leans to one side, thereby enabling controlled tilting. The method further includes progressively adjusting the tension of the tensioning component by selecting different termination points to reduce the support provided by the training wheel assembly as the rider improves balance. Additionally, the method includes adjusting the tensioning component by moving it along a slot on the first bracket to select a specific termination point within the slot to incrementally modify the support level provided to the rider. The method also involves engaging a rotational stop feature on the hinge between the first and second brackets to limit the pivoting range of the training wheel, thereby preventing excessive inward or outward rotation of the training wheel and ensuring stability as the bicycle tilts.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

Although the invention is described herein with reference to specific embodiments, various modifications and changes can be made without departing from the scope of the present invention as set forth in the claims below. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements.

The foregoing detailed description is merely exemplary in nature and is not intended to limit the invention or application and uses of the invention. Furthermore, there is no intention to be bound by any expressed or implied theory presented in the preceding technical field, background, brief summary, or the following detailed description.

What is claimed is:

1. A training wheel assembly for a bicycle, comprising:
a first bracket configured to mount to the bicycle frame;
a second bracket configured to connect to a training wheel; and
a hinge connecting the first and second brackets, allowing the second bracket to pivot relative to the first bracket;
wherein a tensioning component is operatively connected between the first and second brackets, the tensioning component applying an inward force that causes the second bracket and the training wheel to move toward the rear wheel of the bicycle, thereby providing support to the rider as the bicycle tilts.

2. The training wheel assembly of claim 1, wherein the tensioning component includes multiple selectable termination points on at least one of the first bracket or the second bracket, allowing for adjustable tension levels to provide varying support as the rider's skill level progresses.

3. The training wheel assembly of claim 2, wherein the selectable termination points are positioned along a slot on the first bracket, enabling the tensioning component to be adjusted by securing it at different points along the slot.

4. The training wheel assembly of claim 1, further comprising a rotational stop feature on the hinge that limits the pivoting range of the second bracket relative to the first bracket, thereby preventing excessive inward rotation of the training wheel.

5. The training wheel assembly of claim 4, wherein the rotational stop feature includes an emergency stop that limits the outward rotation of the second bracket relative to the first bracket, providing stability by preventing the training wheel from moving beyond a safe tilting angle.

6. The training wheel assembly of claim 1, wherein the tensioning component comprises an elastic material with a reinforced braided exterior, configured to resist over-extension and provide a controlled return force as the bicycle returns to an upright position.

7. The training wheel assembly of claim 1, wherein the hinge includes a pivot pin that enables free rotation between the first and second brackets, allowing the training wheel to adapt to changes in the rider's balance as the bicycle tilts.

8. The training wheel assembly of claim 1, wherein the first bracket includes a frame mounting feature that secures the assembly to the bicycle frame in a fixed orientation, preventing rotation of the training wheel assembly around the bicycle's rear axle.

9. A training wheel assembly for a bicycle, comprising:
a first bracket configured to mount to a rear axle of the bicycle frame, the first bracket including a frame mounting feature that prevents rotation of the training wheel assembly relative to the bicycle frame;
a second bracket pivotally connected to the first bracket and configured to support a training wheel, wherein the second bracket is rotatable relative to the first bracket about a pivot axis;
a tensioning component operatively connected between the first bracket and the second bracket, the tensioning component having a variable tension setting with at least two selectable termination points on the first bracket, enabling adjustment of the inward force applied to the second bracket; and
a rotational stop feature positioned on the hinge between the first and second brackets, limiting the range of inward and outward rotation of the second bracket relative to the first bracket;
wherein the tensioning component applies an inward force that causes the second bracket and the training wheel to move toward the rear wheel of the bicycle, providing support to the rider as the bicycle tilts, and wherein the adjustable termination points allow for varying levels of support based on the rider's balance proficiency.

10. The training wheel assembly of claim 9, wherein the selectable termination points are arranged along a slot on the first bracket, allowing the tensioning component to be adjusted by securing it at different positions along the slot.

11. The training wheel assembly of claim 9, wherein the tensioning component comprises an elastic material with a braided outer layer to resist over-extension, providing a controlled return force that assists the training wheel in returning toward the rear wheel as the bicycle rebalances.

12. The training wheel assembly of claim 9, wherein the rotational stop feature includes an emergency stop that limits the outward rotation of the second bracket relative to the first bracket, preventing the training wheel from rotating excessively outward and providing added stability during leaning.

13. The training wheel assembly of claim 9, wherein the hinge includes a pivot pin that connects the first bracket and the second bracket, allowing the second bracket to pivot freely relative to the first bracket to accommodate changes in the bicycle's tilt.

14. The training wheel assembly of claim 9, wherein the frame mounting feature on the first bracket is configured to interlock with the rear axle mount of the bicycle frame, securing the training wheel assembly in a fixed orientation and preventing rotational movement around the axle.

15. The training wheel assembly of claim 9, further comprising an adjustable tension setting that allows the tensioning component to be tightened or loosened by moving the termination point along the first bracket, enabling a gradual reduction of support as the rider develops improved balance.

16. The training wheel assembly of claim 9, wherein the second bracket includes a stop feature positioned to engage with the hinge, thereby limiting inward rotation of the training wheel relative to the rear wheel to prevent destabilization.

17. The training wheel assembly of claim 9, wherein the tensioning component is configured to generate increased tension as it extends, thereby providing additional support as the bicycle tilts further away from an upright position.

18. A method of using a training wheel assembly to support a rider on a bicycle, the training wheel assembly comprising a first bracket mounted to the bicycle frame, a second bracket connected to a training wheel and pivotally attached to the first bracket, and a tensioning component connected between the first and second brackets, the method comprising:
mounting the first bracket of the training wheel assembly to the rear axle of the bicycle frame to prevent rotation of the assembly relative to the frame;
securing the training wheel to the second bracket, allowing the second bracket to pivot relative to the first bracket about a pivot axis;
adjusting the tensioning component by selecting a termination point on at least one of the brackets to set an initial level of inward force that causes the training wheel to move toward the rear wheel of the bicycle, providing stability for the rider;
setting the tensioning component to apply an adjustable inward force that supports the rider as the bicycle tilts, allowing the training wheel to extend outward when the bicycle leans to one side, thus enabling controlled tilting; and
progressively adjusting the tension of the tensioning component by selecting different termination points, thereby reducing the support provided by the training wheel assembly as the rider improves balance.

19. The method of claim 18, further comprising the step of adjusting the tensioning component by moving it along a slot on the first bracket, thereby selecting a specific termination point within the slot to incrementally modify the support level provided to the rider.

20. The method of claim 18, further comprising the step of engaging a rotational stop feature on the hinge between the first and second brackets to limit the pivoting range of the training wheel, thereby preventing excessive inward or outward rotation of the training wheel and ensuring stability as the bicycle tilts.
